(19) United States
(12) Patent Application Publication
(10) Pub. No.: US 2010/0100562 A1
(43) Pub. Date: Apr. 22, 2010

(54) Fully Parameterized Structured Query Language

(76) Inventor: Jerry Millsap, Capistrano Beach, CA (US)

Correspondence Address: KLEINBERG & LERNER, LLP, 1875 CENTURY PARK EAST, SUITE 1150, LOS ANGELES, CA, 90067, US

(21) Appl. No.: 12/572,261

(22) Filed: Oct. 1, 2009

Related U.S. Application Data
(60) Provisional application No. 61/101,937, filed on Oct. 1, 2008.
(60) Provisional application No. 61/164,349, filed on Mar. 27, 2009.

(51) Int. Cl. G06F 17/30; G06T 11/20; G06F 3/048

(52) U.S. Cl. 707/770; 345/440; 715/810; 707/E17.014; 707/E17.032; 707/769

(57) ABSTRACT

A method for selectively creating a chart and dynamically displaying the chart is disclosed. The method comprises retrieving dimensions from a database, retrieving metrics from said database, retrieving dates from said database, creating user selectable menus, dynamically generating a query based on user selections in said user selectable menus, receiving the results of said query, and dynamically generating a chart from said results.

### CROSS REFERENCE TO RELATED APPLICATIONS

The present application claims priority to U.S. Provisional Patent Application No. 61/101,937, filed Oct. 1, 2008, and to U.S. Provisional Application 61/164,349, filed Mar. 27, 2009, the entirety of which are hereby incorporated by reference for all purposes.

### BACKGROUND

1. Field of the Invention

The present invention relates to managing data in database management systems and dynamically creating queries for the review and visualization of records.

2. Background of the Invention

Traditionally, reports and dashboards were generated using individual constructed Structured Query Language (“SQL”) queries where each query was specific to a particular database table. If an organization desired to generate reports it had to construct individual queries for each report, written to a specific database table. In essence, each query was unique and was hard-wired to a specific database table. This method becomes problematic for companies that require many reports to satisfy all their database reporting needs. For large databases, the traditional method could require hundreds and thousands of individually constructed queries to be created.

Recently, there have been developments in the database reporting where parts of the query structure are dynamic. However, these methods still require an end-user to open separate reports and work through varied formats resulting in the same numerous reports being created for each desired analysis. These methods cannot leverage one dashboard or report format that can be utilized for an entire database for all different types and combination of analysis.

It can be seen, then, that there is a need in the art for a method which allows the end-user to generate dynamic dashboards and reports for any database at the execution-run time level using dynamic fully parameterized SQL queries. It can also be seen that there is a need in the art for a method that can leverage one dashboard or report format across an entire database.

### BRIEF SUMMARY OF THE INVENTION

The present invention is a method or system for dynamically creating reports or charts from records retrieved from a database or databases. This is advantageous over the prior art because it allows a single user with no technical experience to review, manipulate and compare a series of reports or charts with little to no wait in between reports or charts. The present invention eliminates the need to manually enter complicated queries (such as SQL queries) in order to generate a report. It is also an advantage over the prior art because many reports can be generated quickly, and to many users, with reduced load on the database.

In the preferred embodiment the end user interacts with the system of the present invention through a “dashboard.” A dashboard, broadly speaking, is a chart, graph, dial or other visual aid that communicates information to a user. In many instances dashboards incorporate many visual aids, some or all of which may be interactive and presented to the user through the display screen of a computer.

In the preferred embodiment the system of the present invention begins with a user entering a user name and password into a secured log in screen on the internet. Upon successful login, the system detects which databases the user is allowed to access. The system displays a blank dashboard and populates a menu with the databases the user has access to. Upon selecting a database the system populates the remaining menus with chart types and dimensions, metrics and dates present in the database. By selecting these parameters in the related menus the user can dynamically create new reports or charts for their review. In the preferred embodiment, a new report or chart is dynamically generated each time a user alters a menu selection.

Dynamic reports are generated through fully parameterized search queries. The system uses each menu selection as a parameter of a search query to retrieve the appropriate records from the database. The system then displays those records according to the chart type selected by the user.

In a preferred embodiment of the invention a commenting function is incorporated into the dashboard. By clicking on the comment button a user can write a comment on the currently viewed chart or report. The comment is saved along with the parameters used to create the chart. Other users with permission to view that comment can log into the system and retrieve the comment. The system dynamically recreates the chart using the saved parameters.

Another feature of an embodiment of the invention is a calculations function incorporated into the dashboard. This function allows the user to perform calculations on the records making up a chart or report. Some possible calculations include determining an average value of the records, performing regression analysis, or determining a mean value. However, nearly any mathematical function that can be expressed as a database query may be added to the calculations function.

Yet another feature of an embodiment of the invention is the ability to “drill down” and “drill across” on a single dashboard. Drill down and drill across features allow a user to navigate from one dimension set or database to another. This is advantageous because it allows a user to instantly compare and contrast related or more detailed charts or reports.

Another facet of the present invention is the ability to search for other databases and import your own database. This allows users to compare their own data against third party metrics.

Yet another aspect of the present invention is the ability to dynamically stratify data for ease of analysis. The present system can dynamically group sets of records into different strata for ease of comparison in a pie chart or bell curve chart.

### BRIEF DESCRIPTION OF THE DRAWINGS

FIG. 1 illustrates a traditional method of building reports known in the prior art.

FIG. 2 illustrates an end result of the traditional method of building reports in the prior art.

FIG. 3 illustrates different components of a database table.

FIG. 3a illustrates a static SQL.

FIG. 4 illustrates a block diagram of an exemplary system in accordance with the present invention.

FIG. 5(a) is a dashboard feature of the present invention.

FIG. 6 is an example SQL query.

FIG. 7 is a dashboard feature including an integrated “drilldown” report.

FIG. 8 is a relationship chart illustrating the various modules of an embodiment of the invention.

FIG. 9 is an alternative illustration of the functional elements of an embodiment of the invention.

### DETAILED DESCRIPTION OF THE INVENTION

In the following description of the preferred embodiment, reference is made to the accompanying drawings that form a part hereof, and in which is shown by way of illustration a specific embodiment in which the invention may be practiced. It is to be understood that other embodiments may be utilized and changes may be made without departing from the scope of the present invention.

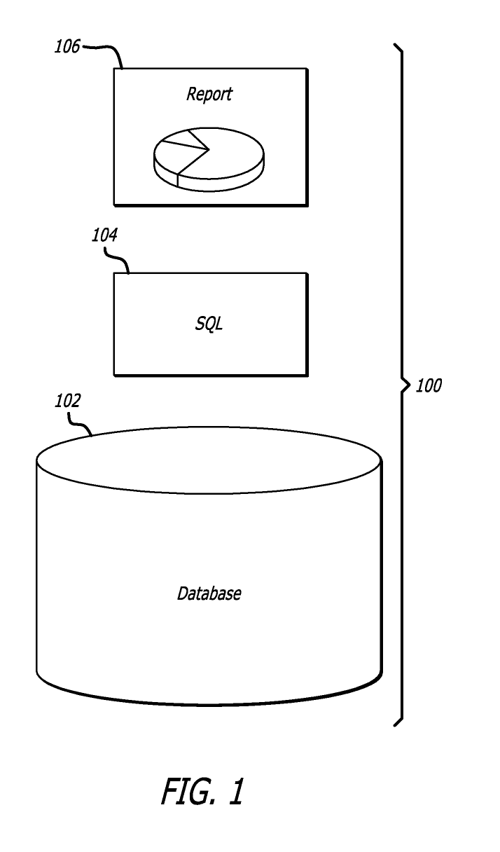

FIG. 1 illustrates a traditional method of building reports known in the prior art.

Traditional method 100 is shown in FIG. 1, with Database 102, SQL 104, and Report 106 as indicated.

The traditional method 100 requires a user to build a unique, individually constructed Structured Query Language 104 (“SQL”) for each desired Report 106. Building unique SQL 104 for each Report 106 means that each unique SQL 104 is hard-wired to a Database 102. The SQL 104 which creates these reports must request the desired information from a Database 102. SQL 104 cannot request information from a different database without being manually rewritten.

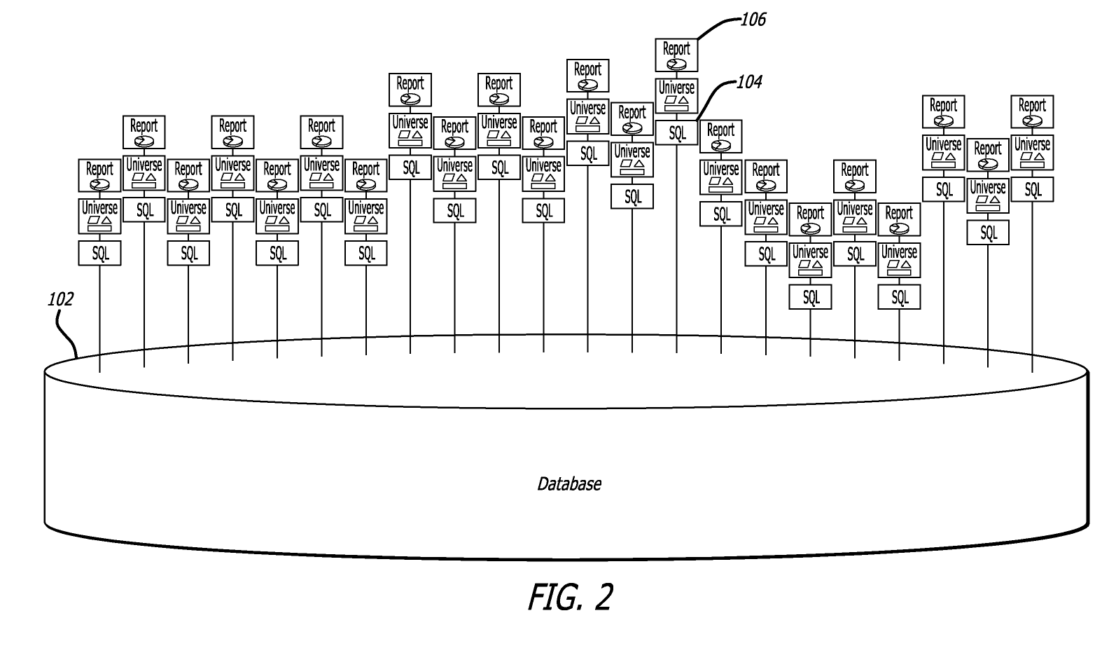

FIG. 2 illustrates an end result of the traditional method of building reports in the prior art.

If an organization wants to generate a report on accounts payable or accounts receivable, it would need to construct individual queries for each report, designed for a specific database table. For a large corporation, it is not uncommon to create hundreds of reports to satisfy its business needs. As illustrated in FIG. 2, typical reporting system for a business can have hundreds of reports to satisfy its database reporting. Even more significant is that Databases 102 can have thousands of usable columns and rows. This means that potentially hundreds or thousands of individually built SQLs 104 and Reports 106 are needed for today's business.

As noted above, it remained for the present inventor to recognize that rather than hard-wiring SQLs 104 to a database 102 to create different reports 106, parameterized SQL can be used to create reports dynamically in a single report or dashboard template. Indeed, the present invention significantly reduces the amount of work required to build queries, and reports.

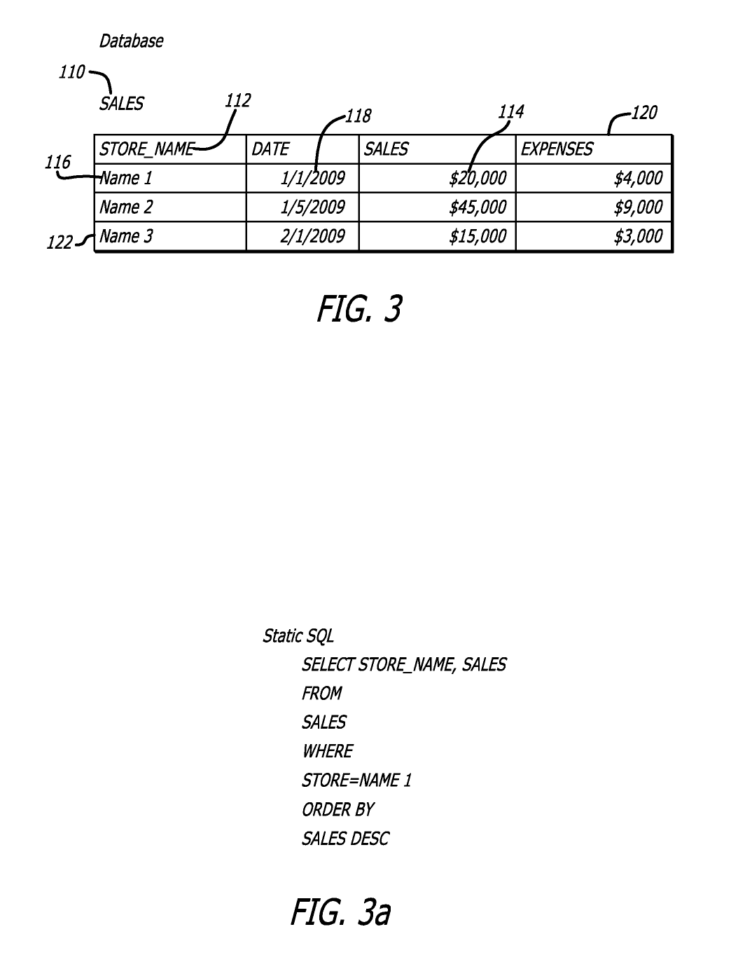

FIG. 3 illustrates different components of an example database table.

Database table 108 is shown in FIG. 3, with database name 110, database parameters 112, numerical attribute 114, text attribute 116, date attribute 118, columns 120, and rows 122.

Traditionally, if an end-user desired to create a report which presents sales numbers for a particular store name, the end user had to first create a static SQL 104, illustrated by FIG. 3a. The static SQL 104 first selects the store name and its sales numbers, parameters 112, from the database table 108. Then, from the selected parameters 112, the SQL 104 further selects the text attribute 116, or numerical attribute 114 that corresponds to the desired output. Once the static SQL 104 gathers the necessary information from the database 108, the end-user can use the output to build the reports. This process must repeat for each desired report. As will be explained more fully below, the present invention completely parameterizes SQL 104 and allows the user to pass the parameters at runtime during execution.

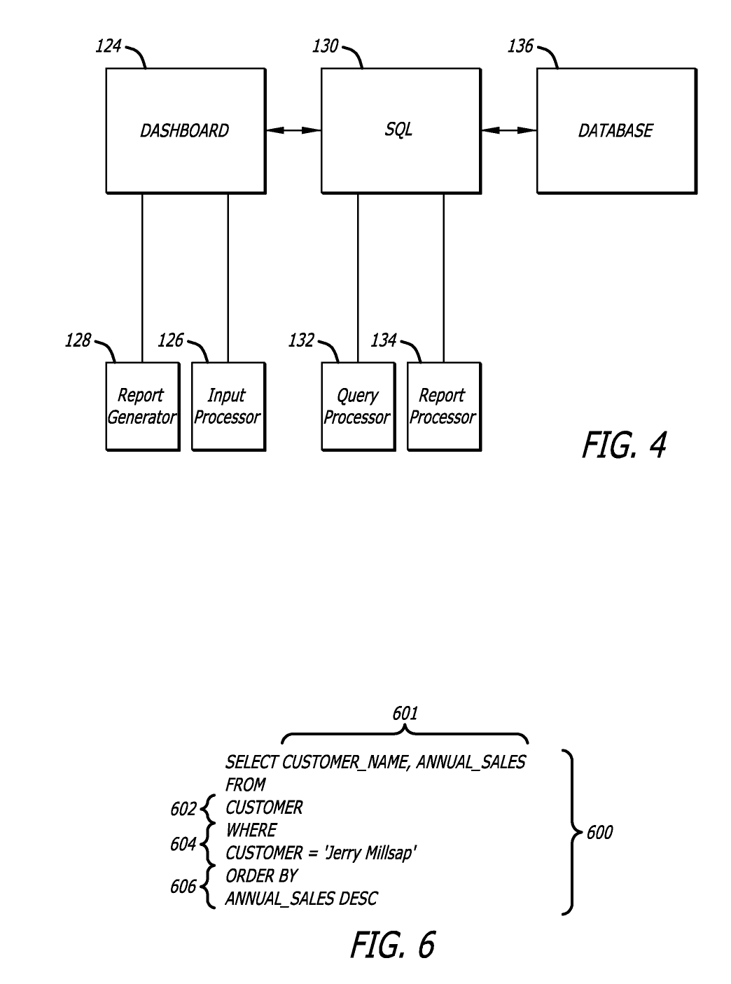

FIG. 4 illustrates a block diagram of an exemplary system in accordance with the present invention.

A Dashboard template 124 is shown, comprising an input processor 126 and a report generator 128. Dashboard template 124 interfaces with dynamic SQL 130, which comprises query processor 132 and report processor 134. Dynamic SQL 130 interfaces with database 136.

The Dashboard template 124 processes end-users's input selection through the input processor 128 which passes along the input information to dynamic SQL 130. Dynamic SQL 130 creates a query and retrieves the desired information from the database 136 through query processor 132. Then, the query processor 132 passes along the information to the report processor 134. The report processor then interacts with the dashboard template 124 which then displays the information through the report generator 126.

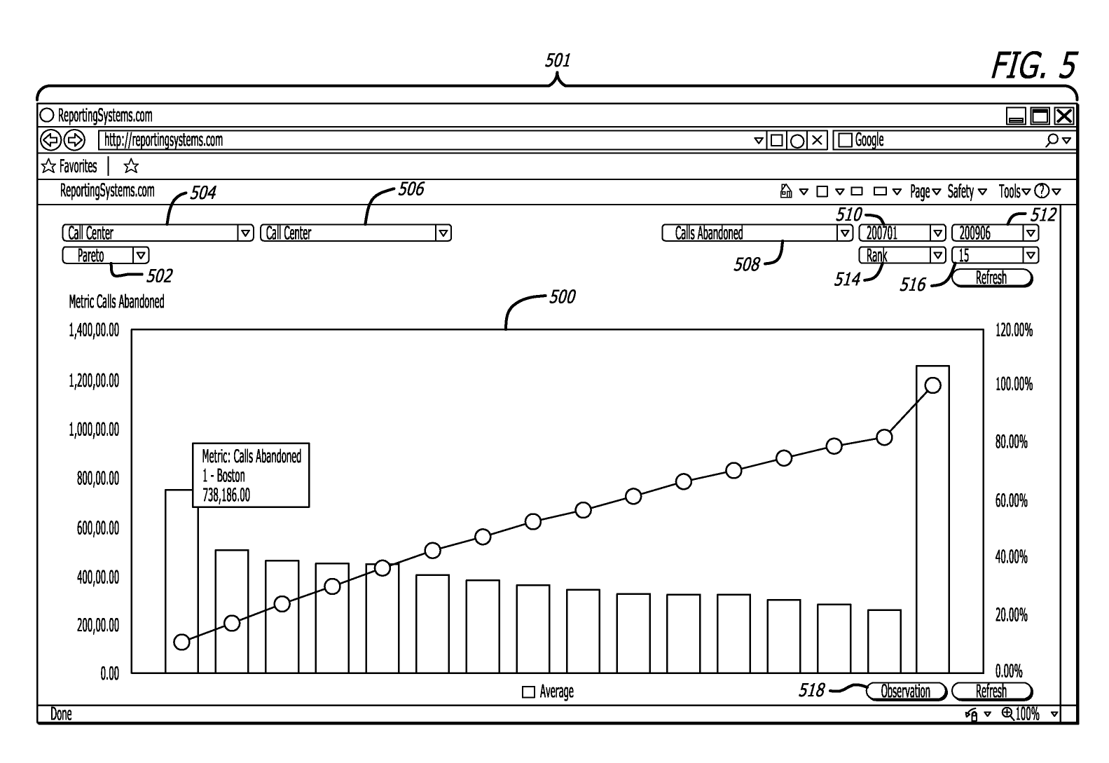

FIG. 5 is a representation of a dashboard 501 produced by an embodiment of the present invention. In this embodiment the dashboard 501 is produced in a web browser connected to the internet. The report of the figure is expressed in a Pareto chart 500 displayed on the dashboard 501. The report could also be expressed in other types of charts. In the preferred embodiment chart type is selected by the user from a menu prior to accessing the dashboard 501. In addition, the user could change the chart type from the dashboard using a chart menu 502. In the preferred embodiment reports are expressed through Pareto, bar, pie and line charts. However, the invention is not limited to these chart types, and reports could be expressed through other types of charts without deviating from the spirit of the invention. In this embodiment each bar or point on the chart is interactive. A pop up graphic is displayed on the chart with numeric data regarding the data point the user hovers the mouse pointer over.

In addition to the chart 500, FIG. 5 illustrates several other aspects of the present invention. At the top of the browser window several menus, 504, 506, 508, 510, 512, 514 and 516 are illustrated. These menus are dynamically generated when a user logs onto the system. The menu populating module, 806, populates these menus with the appropriate choices at login by determining the databases the user has access to and then retrieving all of the appropriate menu choices from the databases at once. In the preferred embodiment it stores the menu choice information. This increases the speed of the invention when the user wants to quickly generate a succession of reports from different databases. The invention does not have to access the database, or series of databases, in order to generate the correct menu choices.

Menu 504 lists the databases available to the user. For example, the user may be able to view databases related to a warranty call in center, sales, and repair and replacement. In another example, other users may be able to access generally available databases of business metrics as well as databases of internal business metrics. Next, menu 506 dynamically lists all of the dimensions that are present in the database selected from menu 504. Dimensions are fields or categories of data present in the database. Menu 508 dynamically lists all of the metrics that are present in the database. Each metric in menu 508 is a type of numerical entry in the database that can be compared across fields or databases for analysis. Menus 510 and 512 dynamically list all of the date entries present in the database. The user can set a time period for analysis by setting menu 510 to a beginning date and menu 512 to an ending date. Menu 514 is used to set the ranking method, and determines whether the report displays results that have the most, or the least, of a given metric. Menu 516 sets the number of results to return in a report. By using menus 514 and 516 together the user can specify how many records a report should contain, and whether those records should be drawn from the top or bottom of the range.

A refresh button is present below the menu 516 illustrated in FIG. 5. In the illustrated embodiment the user must click the refresh button after making menu selections to generate a new report. In other embodiments a refresh button is omitted, and a new report is dynamically generated each time the user makes a new menu selection.

Element 518 is a clickable button on the dashboard 501 that allows a user to make an observation or comment. A pop up window opens where the user can input a title and short comment. The title and comment are saved along with the parameters used to create the report. Later, another user can access and view the comment, along with a new copy of the report dynamically generated from the saved parameters.

FIG. 6 displays a sample SQL query 600 of the prior art. The SQL query 600, or select statement, selects database records for display in a report. In the present example the query 600 is requesting records from a database table 602 named “Customer.” The query is requesting records selected from the fields 601 “Customer_Name” and “Annual_Sales.” However, the query has restricted its request to records where the Customer is Jerry Millsap using a “Where” clause 604. The “Order by” clause 606 creates a report with records sorted in a descending order on the basis of annual sales. To dynamically generate a report using the method of the present invention a user could use the menus present in FIG. 5 instead of manually creating a SQL query. A user could select “Customer” from menu 504, “Customer Name” from menu 506 and “Annual Sales” from menu 508. A user could use the remaining menus to alter the number of records presented in the report or alter their presentation. Importantly, a user could dynamically generate a number of reports from the same dashboard 501 merely by changing the menu selections.

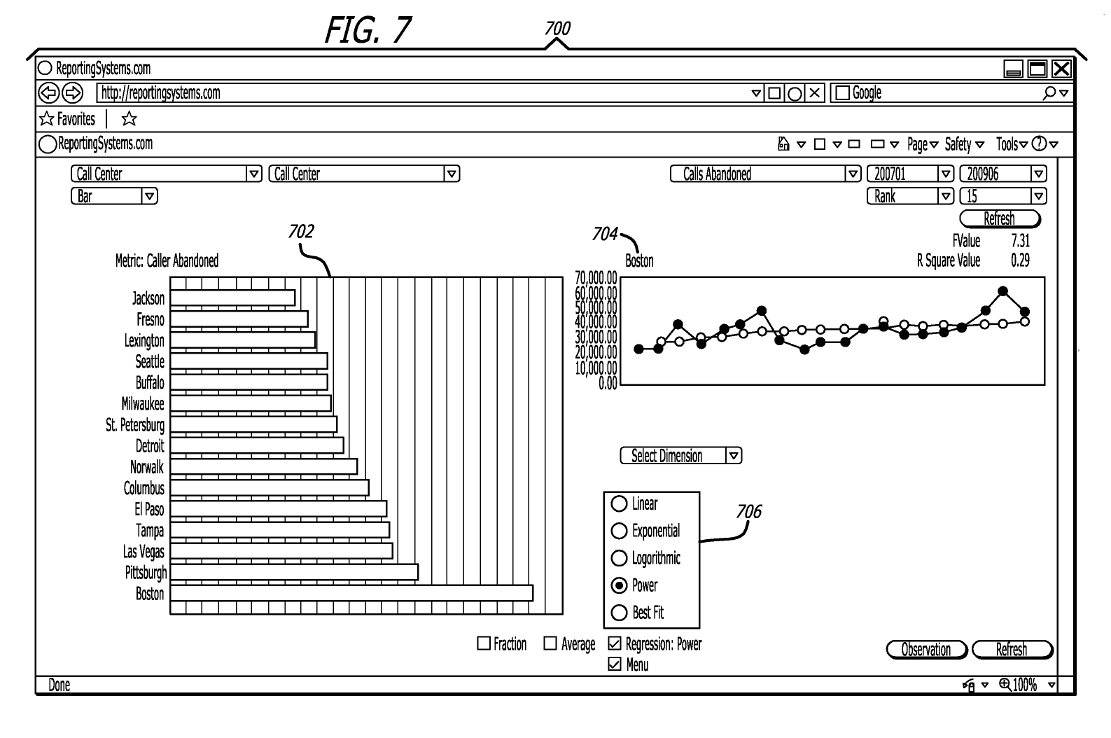

FIG. 7 illustrates another embodiment of the present invention. In FIG. 7 a dashboard 700 is presented that incorporates a “drilldown” report. The dashboard 700 incorporates the menu items and main chart 702 from FIG. 5. In addition, it also includes a detailed chart 704 about one of the values in the main chart 702. The detailed chart is generated dynamically when the user clicks on an interactive element of the main chart. In this example, the main chart was dynamically created from the database “Call Center,” field “Call Center,” and metric “Calls abandoned.” The charts cover date ranges from January 2007 to June 2009, and are limited to 15 records.

Chart 702 shows the total number of calls abandoned at the call centers in 15 cities. The user has selected a detailed report for “Boston” the call center with the most abandoned calls. The detailed chart 704 shows a line chart of the abandoned calls over the period from January 2007 until June 2009. The user could change the detailed chart 704 by clicking on a different city in the main chart 702.

Element 706 is an interface for performing mathematical operations on the records making up a report. In the embodiment of FIG. 7 the interface is composed of interactive check boxes for “fraction,” “average,” “regression” and “menu.” “Fraction” adds a new menu to the dashboard 700 or 501. The new menu allows a user to select a new numeric metric to act as a denominator. Once a denominator is selected a new report is dynamically generated that charts the relationship of the original metric compared to the denominator metric. For example, in FIG. 7 a user could use the “fraction” button to add a new denominator metric of “Calls Answered.” This would dynamically generate a new report and chart 702 that showed the ratio of abandoned calls to answered calls at 15 call centers. The “average” button calculates an average and inserts a line at the average value on the main chart. The “regression” button calculates a regression for the records in the main chart and inserts a regression line into that chart. The “menu” button allows a user to choose between types of regressions, including, for example, linear, exponential, logarithmic, power and best fit. Nearly any mathematical operation that could be expressed as a database query could be added to the dashboard as a calculation. One potential calculation would be the insertion of control lines onto a chart. Another calculation could be the automatic stratification of data into sets for ease of analysis.

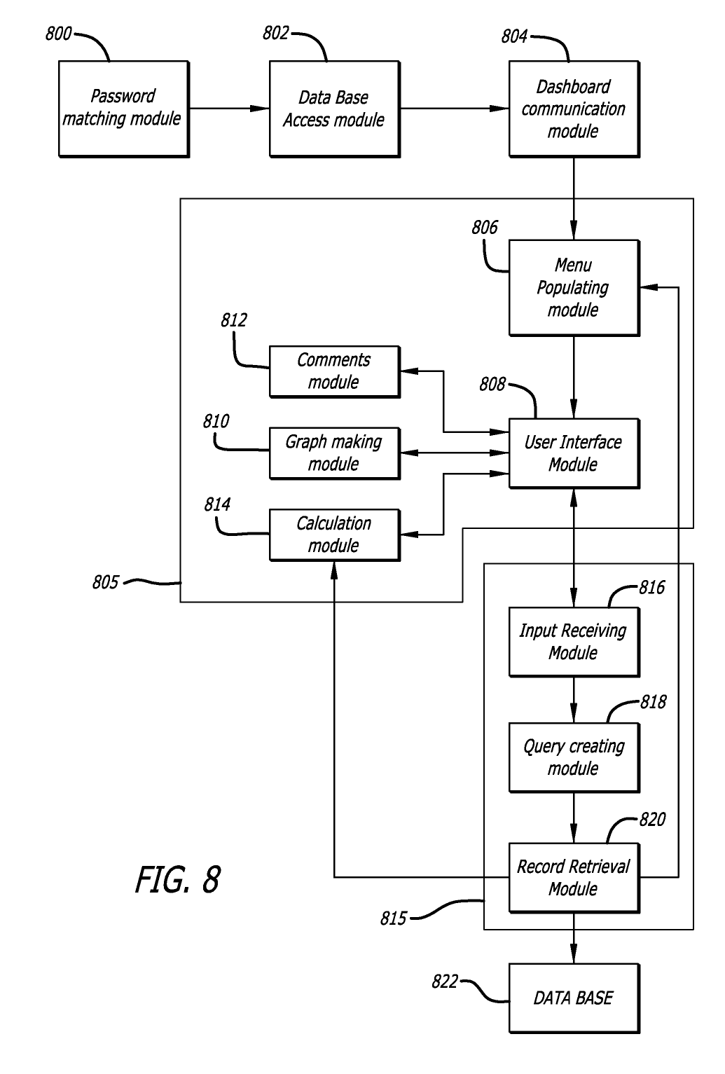

FIG. 8 is a logical flow chart that illustrates the relationship between modules of the present invention. First, a user must login to the system. The password matching module 800 confirms that the user is authorized to access the system. A database access module 802 determines which databases that user is allowed to access. Then a dashboard communication module 804 passes the information about which databases the user can access to the dashboard module 805.

The dashboard module 805 is composed of many sub-modules. Sub-module 806 is the menu-populating sub-module. It receives the database information from module 804 and retrieves the database names, dimensions, metrics, and dates from the database or databases 822. Sub-module 806 then passes that information to sub-module 808, the User Interface module. The user interface module 808 inserts the database names, dimensions, etc. into the on-screen menus of the dashboard 805. When the user selects menu items to dynamically create a report and chart the user interface module 808 passes those selections to the SQL query generating module 815.

SQL query generating module 815 is composed of several sub-modules. Input receiving sub-module 816 receives the user's selections from module 808. sub-module 816 passes that information to SQL Query creation module 818 which creates a SQL query from the user's menu selections. Record retrieval module 820 uses the SQL query created by module 818 to retrieve records. It passes those records to the User Interface sub-module 808 of the dashboard 805.

Sub-module 808 uses the records from module 820 to create and label the interactive elements of the charts of the dashboard 805 and also passes them to module 810 which creates the charts from the database records. Module 808, the user interface module, and module 810, the chart creating module, also interact with module 814, the analysis/calculation module. When the user checks the “fraction,” “average,” or “regression” buttons module 814 performs the calculations to determine the appropriate additions to the charts on the dashboard. The analysis/calculation module 814 obtains the records for its calculations from the record retrieval module 820.

Sub-module 812 handles the writing and storing of observations or comments about a report or chart. It interacts with the user interface module 808.

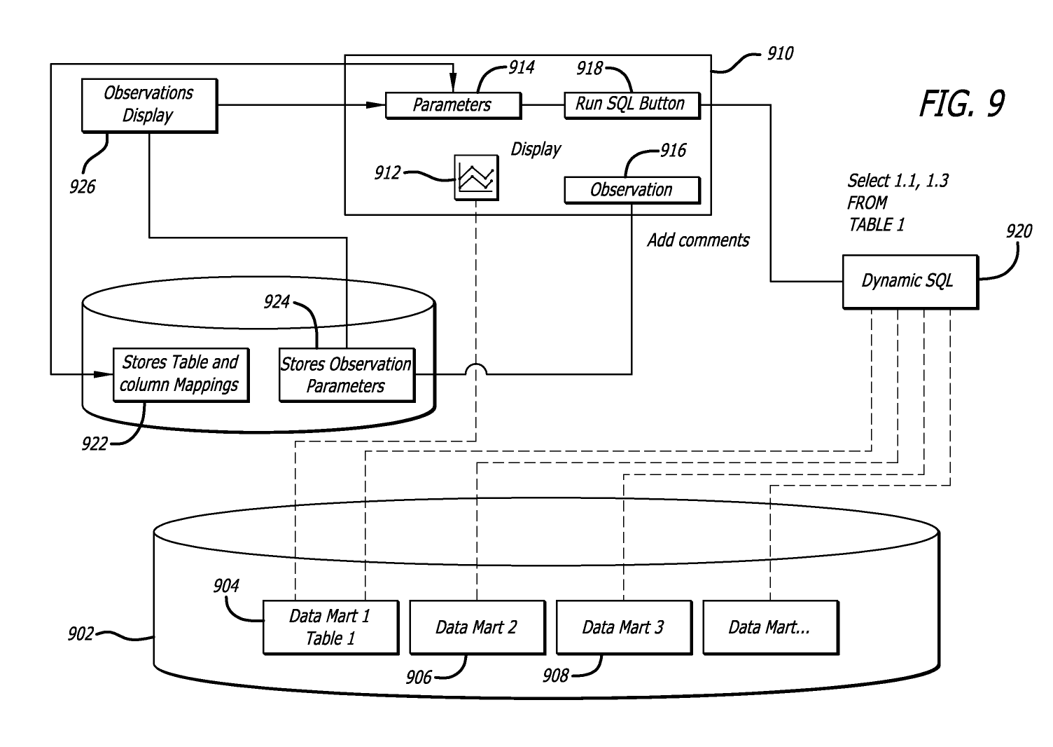

FIG. 9 illustrates an alternative illustration of the functional elements of the present invention. A database 902 contains multiple tables, “Data Mart 1, Table 1,” 904, “Data Mart 2,” 906, “Data Mart 3,” 908 etc. The Display Dashboard 910 contains any charts 912 that have been generated, parameters 914 for the menus, an observation or commenting function 916, and a “Run SQL Button,” 918. (In this embodiment database queries are performed when the Run SQL Button is clicked, rather than automatically when a user changes a menu item.) First a user sets parameters 914 in the dashboard 910, then clicks the Run SQL Button 918. A Dynamic SQL 920 is created based off of those parameters. A report is generated from the records retrieved from the database 902 by the dynamically created SQL query 920 and displayed in a chart 912 form on the dashboard 910.

If the observation or commenting button 916 is clicked on the dashboard 910 then observation parameters 924 are stored when the observation 916 is saved. Those parameters 924 are later accessed to form an observation 926 display within which later users can access and view the comment and chart 912 generated by those parameters 914. Table and column mappings 922 for database parameters 914 are collected from the databases and stored so that the main database 902 need not be accessed to determine these mappings, thus speeding up access and rendering of charts.

What is claimed is:

1. A method for creating a report from a database, the method comprising:
retrieving dimensions from a database, retrieving metrics from said database, retrieving dates from said database;
creating user selectable menus, wherein each of said menus is created from elements of said database, said menus comprising at least
a first user selectable menu created from said dimensions,
a second user selectable menu created from said metrics,
a third user selectable menu created from said dates,
a fourth user selectable menu created from said dates;
dynamically generating a query based on user selections in said user selectable menus,
receiving the results of said query,
and dynamically generating a chart from said results.

2. The method of claim 1, wherein said query and said chart update with user selections.

3. The method of claim 2, wherein said database is stored on a computer readable medium.

4. The method of claim 3, wherein said chart is generated and displayed on a computer system.

5. The method of claim 4, wherein said database is remotely accessed by said computer system.

6. A computer program product, comprising a computer usable medium having a computer readable program code embodied therein, said computer readable program code adapted to be executed to implement a method for dynamically generating reports, said method comprising:
providing a system, wherein said system comprises distinct software modules, and wherein the distinct software modules comprise a user interface module, a menu populating module, a chart creating module, a query creating module, a record retrieval module and at least one database;
creating a user interface comprising menus, wherein said creating is performed by said menu populating module by
retrieving dimensions from said database, retrieving metrics from said database, retrieving dates from said database,
selecting a dimension, a metric and two dates from said user interface, wherein said selecting is performed by a user using said user interface,
dynamically creating a query from said dimension, said metric and said two dates, wherein said query is dynamically created by said query creating module,
retrieving records from said database according to said query, wherein said records are retrieved by said record retrieval module,
dynamically generating a chart from said records, wherein said chart is dynamically generated by said chart creating module.

7. The product of claim 6, wherein said system also comprises a commenting module, and wherein said system also includes
creating, storing and associating comments with a dynamically generated chart, wherein said creating is performed by a user and wherein said storing and associating is performed by a commenting module.

8. The product of claim 6, wherein said system also comprises a calculations module, and wherein said system also includes
performing calculations on said records and dynamically generating a chart, wherein said calculations are performed by said calculations module and said dynamically generating a chart is performed by said chart creating module.

9. The product of claim 6, wherein said system dynamically generates multiple charts from said records, wherein said charts are dynamically generated by said chart creating module, and said charts have identical metrics and dates.

10. The product of claim 6, wherein said system dynamically generates multiple charts from said records, wherein said charts are dynamically generated by said chart creating module, and said charts have identical dimensions and dates.

11. The product of claim 6, wherein a user can search for and select a database from a multiplicity of databases for use with said method.

12. The product of claim 6, wherein a user can create a database for use with said method.

13. The product of claim 6, wherein said database is stored on a computer readable medium.

14. The product of claim 6, wherein said menu populating module retrieves said dimensions, said metric and said dates from a database that is accessed through the internet.
